(19) United States
(12) Patent Application Publication
(10) Pub. No.: US 2008/0034989 A1
(43) Pub. Date: Feb. 14, 2008

(54) Squeegee and Device for Screen-Process Printing

(75) Inventors: Ewald Koenig, Wyhl (DE); Elmar Winterhalter, Endingen (DE); Klaus Messmer, Freiburg (DE)

Correspondence Address: CROWELL & MORING LLP;INTELLECTUAL PROPERTY GROUP, P.O. BOX 14300, WASHINGTON, DC, 20044-4300, US

(73) Assignee: THIEME GmbH & Co. KG, TENINGEN (DE)

(21) Appl. No.: 10/572,398

(22) PCT Filed: Aug. 26, 2004
(86) PCT No.: PCT/EP04/09527

§ 371 Date: Feb. 27, 2007

(30) Foreign Application Priority Data
Sep. 16, 2003 (DE) 103 44 023.2

(51) Int. Cl. B41F 15/08

(52) U.S. Cl. 101/123

(57) ABSTRACT

A screen printing squeegee doctor blade includes an elastic application element and a maintaining or gripping device. The grip is subdivided into several grip sections which can be displaced in relation to each other over the width of the screen printing doctor blade. The squeegee may be used, for example, for printing curved vehicle windshields.

### CROSS-REFERENCE TO RELATED APPLICATIONS

This application is related to co-pending U.S. patent application Ser. No. ______, entitled “Device and Method for Screen-Process Printing”.

### BACKGROUND AND SUMMARY OF THE INVENTION

The invention relates to a squeegee for screen-process printing having an elastic applicator and a grip. The invention also relates to a device for screen-process printing having a squeegee according to the invention.

Conventional devices for screen-process printing are suitable for imprinting planar items, e.g., planar glass panes employed on automobiles. For example, the conductors of automobile rear-window defrosters may be applied to planar glass panes. Once the conductors have been imprinted, the panes are heated and bent, which will simultaneously harden the ink imprinted thereon.

A device for imprinting rotationally symmetric solid objects is known from German disclosure statement 214 31 37. In the case of that device, those surfaces of rotationally symmetric solid objects that are to be imprinted are rolled over a stationary screen. A squeegee that forces ink residing on the printing screen through the screen and onto the surface of the item rolled over is moved along the other side of the screen, i.e., that side thereof that faces away from the surface to be imprinted. However, such a device for screen-process printing is suitable for use on rotationally symmetric surfaces only.

The invention is intended to allow imprinting arbitrarily curved surfaces using screen-process printing.

According to the invention, a squeegee for screen-process printing having an elastic applicator and a grip, where the grip is subdivided into several segments that are distributed over the width of the squeegee and free to move relative to one another, is provided for that purpose.

That subdivision of the grip into several segments that are free to move relative to one another allows for adapting the squeegee to suit varyingly curved surfaces of items to be imprinted. Since the grip segments are free to move relative to one another, the squeegee may take on a slightly curved shape starting in the vicinity of the grip segments in order to provide that the squeegee will remain in contact with a printing screen, and thus, indirectly, with the curved surface to be imprinted, over the squeegee's full width throughout an entire printing procedure.

In one embodiment of the invention, the elastic applicator is configured in the form of a monolithic unit and elastically links the several grip segments.

Employing a monolithic applicator provides that ink will be uniformly distributed over the printing screen, while still providing that the squeegee's grip segments will remain free to move relative to one another and, thus, be capable of assuming a curved shape.

In a further development of the invention, the applicator's printing edge, i.e., that edge thereof that faces an item to be imprinted, is curved.

Employing a curved printing edge will allow achieving uniform contact with a curved surface on an item to be imprinted and uniform printing results. If the curved surface that is to be imprinted has a constant curvature along the printing axis, the curvature of the printing edge will be adapted to suit the surface's curvature.

In another development of the invention, a curvature of the applicator's printing edge corresponds to an average curvature of the item to be imprinted transverse to the squeegee's direction of motion.

Due to the applicator's elasticity and the grip segments' freedom to move relative to one another, the squeegee may be adapted to suit items to be imprinted that have varying curvatures, within certain limits. Matching the curvature of the printing edge to the average curvature of the item to be imprinted will minimize the deformations of the squeegee necessitated during printing procedures.

In still yet another development of the invention, a guide plate that abuts against the applicator, at least during a printing procedure, protrudes from every grip segment.

Such guide plates will allow providing for a uniform pressure distribution along the applicator's printing edge, which is of particular importance, since if the applicator's printing edge is curved, a distance between its printing edge and the respective individual grip segments will change. In the case of an applicator fabricated from a material having a constant thickness and homogeneous properties, that would cause the pressure exerted by the printing edge to vary, where that effect may be neutralized by the guide plates. Alternatively, the thickness of the material employed and/or the applicator's elasticity might be varied in concert with the distance between the printing edge and a grip segment.

In a further development of the invention, the guide plates extend downward from the grip segments, i.e., toward the applicator's printing edge, where an edge of the guide plates that faces away from the grip segments is parallel to the applicator's printing edge.

That approach will also provide that a constant pressure will be exerted over the full width of the printing edge.

In another development of the invention, the guide plates are curved, which allows for improving an adaptation to suit the curvature of an item to be imprinted.

The problem on which the invention is based is also solved by a device for screen-process printing, where a squeegee having an elastic applicator and a grip, where the grip is subdivided into several segments that are distributed over the width of the squeegee and free to move relative to one another, is provided, and where every grip segment has at least one controllable adjustment component allocated to it.

That approach will allow individually influencing the pressure exerted by, and/or the deflection of, each grip segment in order to achieve the best-possible adaptation of the squeegee to the curvature of a surface to be imprinted.

### BRIEF DESCRIPTION OF THE DRAWINGS

Further features and benefits of the invention will be evident from the claims and the following description of preferred embodiments of the invention, together with the figures, which depict:

FIG. 1 is a frontal view of a squeegee according to a preferred embodiment of the invention;

FIG. 2 is a view of the squeegee shown in FIG. 1, shown here installed on a section of a device for screen-process printing;

FIG. 3 is a device for screen-process printing according to the invention; and

FIG. 4 is another embodiment of a device for screen-process printing according to the invention.

### DETAILED DESCRIPTION OF THE DRAWINGS

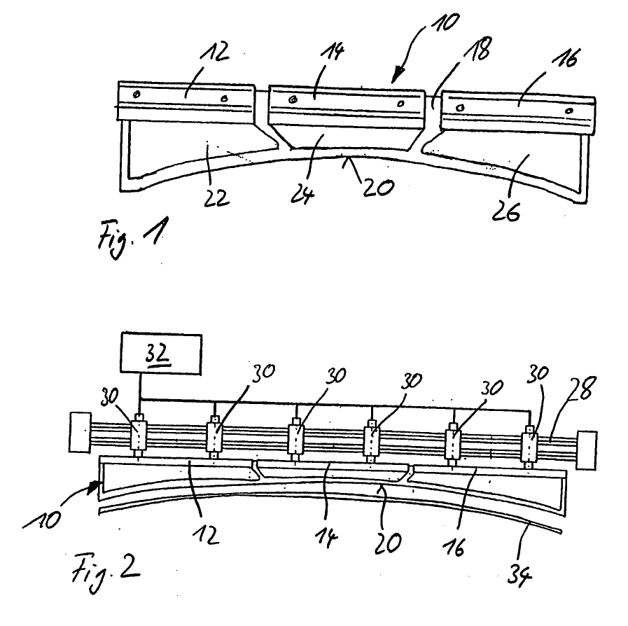

FIG. 1 depicts a squeegee 10 according to the invention that has several grip segments 12, 14, 16. The squeegee 10 is attached to a squeegee holder (not shown) of a device for screen-process printing (also not shown) by way of the grip segments 12, 14, 16. The squeegee 10 also has an elastic applicator 18 consisting of, for example, an elastic rubber plate. The elastic applicator 18 is configured in the form of a monolithic unit over the full width of the squeegee 10 and is held in place at the location of every grip segment 12, 14, 16. The grip segments 12, 14, 16 are spaced at intervals and interconnected by the elastic applicator 18 only. The grip segments 12, 14, 16 are therefore free to move relative to one another.

A printing edge 20 of the squeegee 10 opposite the grip segments 12, 14, 16 is curved, where the curvature of the printing edge 20 is adapted to suit the surface curvature of an item to be imprinted.

A guide plate 22, 24, 26 extending downward from each grip segment 12, 14, 16, i.e., toward the printing edge 20, is attached to each grip segment 12, 14, 16. The guide plates 22, 24, 26 abut against the elastic applicator 18 in order to provide a uniform pressure distribution over the elastic applicator 18, and thus a uniform distribution of the pressure exerted by the printing edge 20 during a printing procedure. A lower edge of the guide plates 22, 24, 26 that faces away from the grip segments 12, 14, 16 is formed parallel to the printing edge 20 of the elastic applicator 18, which will provide for a uniform elastic behavior of the printing edge 20 over the full width of the squeegee 10.

That edge of the left guide plate 22, i.e., that on the left-hand grip segment 12 shown in FIG. 1, that faces the central guide plate 24 on the central grip segment 14 extends downward from the left-hand grip segment 12, toward a center of the printing edge 20, and toward the latter, rather than constituting an extension of the associated, left-hand, grip segment 12. That right-hand lateral edge of the left-hand guide plate 22 extends toward the center of the printing edge 20 to the extent that a projection, vertically upward in FIG. 1, of a corner of the left-hand guide plate 22 neighboring on the printing edge 20 will cover a left-hand border of the central grip segment 14, and thus also partially cover a left-hand border of the central guide plate 24. A left-hand, lateral, edge of the central guide plate 24 extending from the left-hand border of the central grip segment 14 also extends toward the center of the printing edge 20 and is approximately parallel to the right-hand lateral edge of the left-hand guide plate 22. The right-hand lateral edge of the central guide plate 24 is configured symmetrically thereto. The left-hand lateral edge of the right-hand guide plate 26 parallel to it is configured symmetrically to the right-hand lateral edge of the left-hand guide plate 22. That configuration of the guide plates 22, 24, 26 provides for an approximately uniform force distribution over the elastic applicator 18, and, in particular, over its printing edge 20.

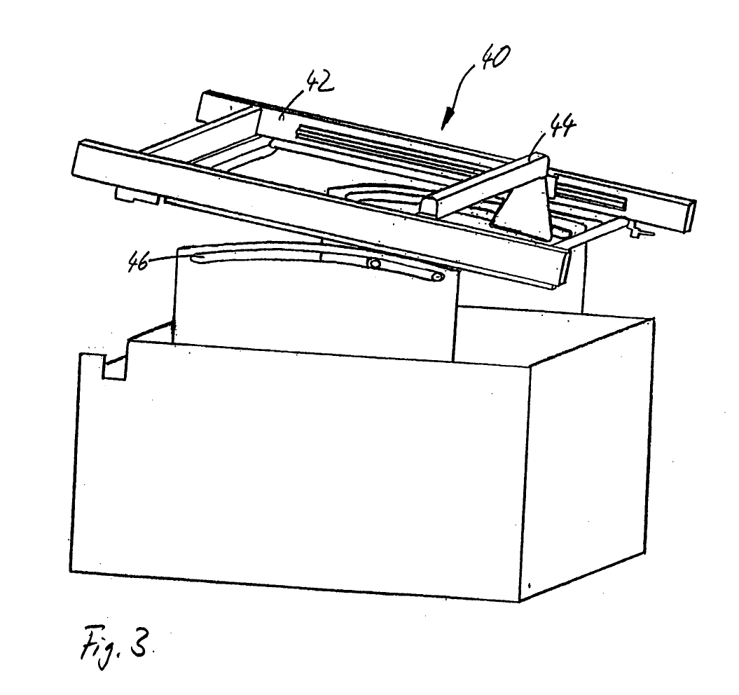

FIG. 2 depicts the squeegee 10 shown in FIG. 1 assembled on a squeegee holder 28. It may be seen that every grip segment 12, 14, 16 is attached to the squeegee holder 28 by way of a pair of adjustment cylinders 30. Each adjustment cylinder 30 may be individually controlled by a controller 32 in order to set a location of the grip segments 12, 14, 16 relative to one another and a pressure exerted by the printing edge 20 of the squeegee 10 that varies over its width. Furthermore, the adjustment cylinders 30 may also be utilized for setting the pressure exerted by, and the location of, the printing edge 20 of the squeegee 10 during a printing procedure differently than for, for example, a return motion of the squeegee.

As may be seen in FIG. 2, the curved printing edge 20 of the squeegee 10 allows a uniform adaptation to suit the curved surface of an item 34 to be imprinted, for example, a final-shaped glass pane for an automobile. In the interest of simplicity, a printing screen that must, necessarily, be arranged between the squeegee 10 and the item 34 to be imprinted is not shown in FIG. 2. Due to the grip segments 12, 14, 16 that are free to move relative to one another and the facilities for individually adjusting the grip segments 12, 14, 16 using the adjustment cylinders 30, the squeegee 10 may also be adapted to suit curvatures of the item 34 to be imprinted that vary over its surface. In the event that the curvature of the item 34 to be imprinted varies along the longitudinal axis, that is, along the direction of motion of the squeegee 10, the curvature of its printing edge 20 will be matched to an average curvature of the item 34 to be imprinted.

The squeegee 10 according to the invention may thus be utilized for imprinting items, like the item 34 to be imprinted shown, that are curved transversely to the imprinting axis using a conventional device for screen-process printing.

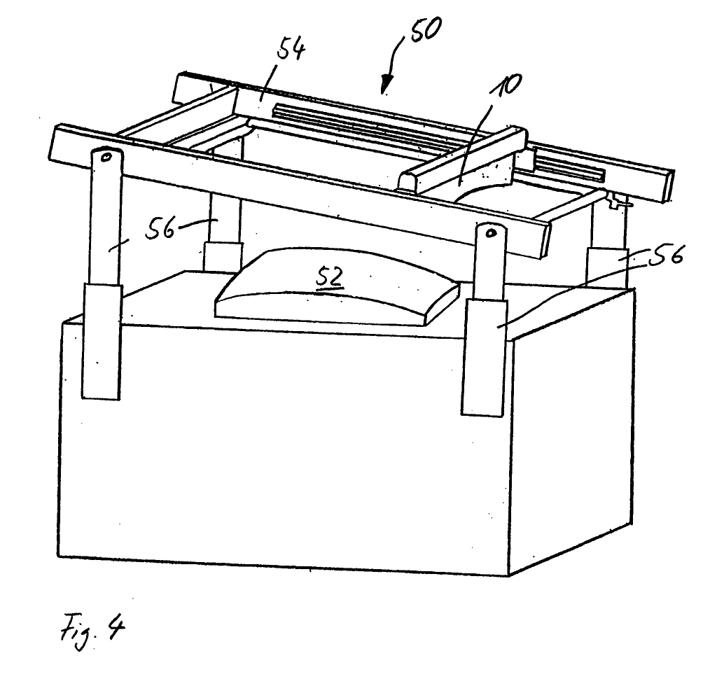

If spherically curved items, for example, final-shaped glass panes for automobiles, are also to be imprinted, a device 40 for screen-process printing similar to that shown in FIG. 3, together with the squeegee 10 according to the invention, may be utilized for that purpose. In the case of the device 40 for screen-process printing, a printing frame 42 may undergo a tilting motion during a printing motion of the squeegee holder 44, together with a squeegee clamped therein, while the squeegee holder 44 is guided such that it remains approximately parallel to a longitudinally curved surface of an item 34 to be imprinted. To that end, the squeegee holder 44 is guided by slotted guides 46 that have been adapted to suit the longitudinal curvature, that is, the curvature along the squeegee's direction of motion, of an item to be imprinted. During the tilting motion of the printing frame 42, which is caused by the motion of the squeegee holder 44 that is guided on the printing frame 42, an underside of the printing frame 42 rocks on a surface parallel to the slotted guides 46, where the surfaces involved in that rocking motion are toothed in order that the printing frame 42 will be constrained from shifting its location longitudinally during a printing motion. Together with the squeegee 10 according to the invention, the device 40 for screen-process printing will thus allow imprinting spherically curved items, that is, items that are curved along both the longitudinal and lateral axes.

FIG. 4 depicts another embodiment of a device 50 for screen-process printing according to the invention. A spherically curved item 52 is to be imprinted using the device 50 for screen-process printing, where a curvature of the surface of the item 52 transverse to the longitudinal axis will be taken into account by the squeegee 10 according to the invention, which is merely schematically depicted in FIG. 4. The longitudinal curvature of the item 52 to be imprinted is taken into account by a tilting motion of a printing frame 54 that, in the case of this particular device 50 for screen-process printing, is generated using four column hoists 56 that are controllable by a controller (not shown). Suitably controlling the operations of the column hoists 56 will adjust the orientation of the printing frame 54 such that the printing frame 54, and thus a printing screen, which is not shown in FIG. 4, will be adjusted such that they remain tangential to an imaginary line of contact between the printing edge of the squeegee 10 and the surface of the item 52 to be imprinted at all times. In contrast to the device 40 for screen-process printing shown in FIG. 3, this device 50 for screen-process printing has column hoists 56 that may be freely programmed in order that reprogramming them will be all that is necessary in order to take into account differing curvatures of the items to be imprinted.

1-8. (canceled)

9. A squeegee for screen-process printing, comprising:
a grip; and
an elastic applicator coupled to the grip, wherein the grip is subdivided into several segments that are distributed over a width of the squeegee and are free to move relative to one another.

10. The squeegee for screen-process printing according to claim 9, wherein the elastic applicator is configured as a monolithic unit and forms elastic links joining the several segments of the grip.

11. The squeegee for screen-process printing according to claim 9, wherein a printing edge of the applicator, which edge faces an item to be imprinted when in use, is curved.

12. The squeegee for screen-process printing according to claim 10, wherein a printing edge of the applicator, which edge faces an item to be imprinted when in use, is curved.

13. The squeegee for screen-process printing according to claim 11, wherein the curvature of the printing edge of the applicator corresponds to an average curvature of the item to be imprinted along an axis transverse to a direction of motion of the squeegee.

14. A squeegee for screen-process printing according to claim 12, wherein the curvature of the printing edge of the applicator corresponds to an average curvature of the item to be imprinted along an axis transverse to a direction of motion of the squeegee.

15. The squeegee for screen-process printing according to claim 9, wherein each grip segment has a guide plate protruding therefrom that abuts against the applicator at least during a printing procedure.

16. The squeegee for screen-process printing according to claim 10, wherein each grip segment has a guide plate protruding therefrom that abuts against the applicator at least during a printing procedure.

17. The squeegee for screen-process printing according to claim 15, wherein the guide plates protruding from the grip segments protrude toward the printing edge of the applicator, where an edge of the guide plates that faces away from the grip segments is parallel to the printing edge of the applicator.

18. The squeegee for screen-process printing according to claim 15, wherein the guide plates are curved.

19. The squeegee for screen-process printing according to claim 17, wherein the guide plates are curved.

20. A device for screen-process printing, the device comprising:
a squeegee including an elastic applicator and a grip, where the grip is subdivided into several segments that are distributed over a width of the squeegee and are free to move relative to one another, and wherein every grip segment is allocated to at least one controllable adjustment component.
